(19) United States
(12) Patent Application Publication
(10) Pub. No.: US 2012/0110434 A1
(43) Pub. Date: May 3, 2012

(54) AUTOMATED DOCUMENT GOVERNANCE

(75) Inventors: Ramakrishna Janardhana Gorthi, Pune (IN); Oriana Jeannette Love, Austin, TX (US); David Walsh Palmieri, Cary, NC (US); Jeffrey Tobias Robke, Durham, NC (US)

(73) Assignee: INTERNATIONAL BUSINESS MACHINES CORPORATION, Armonk, NY (US)

(21) Appl. No.: 12/915,181

(22) Filed: Oct. 29, 2010

(51) Int. Cl. G06F 17/00

(52) U.S. Cl. 715/234

(57) ABSTRACT

A method, system, and computer usable program product for automated document governance in a data processing environment are provided in the illustrative embodiments. A set of structured documents is received at an application executing in a computer in the data processing environment. A structure is recognized, parts of which structure are present in the documents in the set. A set of similarities in the documents in the set is summarized according to the recognized structure. A summarized information from the summarizing is presented such that a document governance action can be performed on a subset of the set of documents using the summarized information.

### BACKGROUND OF THE INVENTION

1. Field of the Invention

The present invention relates generally to an improved data processing system, and in particular, to a computer implemented method for processing volumes of information in a data processing environment. More particularly, the present invention relates to a computer implemented method, system, and computer usable program code for automated document governance in a data processing environment.

2. Description of the Related Art

Information in a data processing environment, such as in a corporate environment has to be subjected to certain governance. For example, contents of certain documents may have to be distributed, reviewed, commented on, modified, authorized, certified, or approved.

As an example, an author or an application may generate several documents. Before the documents can be used, they may have to pass through certain governance steps, such as ensuring that the content complies with certain policies.

Frequently, content that requires some combination of governance activities can take the form of a large collection of documents. In such circumstances, it is not uncommon to have a team of personnel collaborating on the governance activities. For example, a team of authors may generate the documents, a team of reviewers may review and modify the documents, and a team of approvers may approve the documents or changes.

Additionally, the need for governance arises not only for new content in a data processing environment but also for content that is being revised. For example, roles of a group of employees in an organization may change due to a merger, an acquisition, a restructuring process, or for installing a new management system. Such a change may cause a large number of employee records documents to undergo revision, the revisions being subject to some control or governance action.

### SUMMARY OF THE INVENTION

The illustrative embodiments provide a method, system, and computer usable program product for automated document governance. An embodiment receives at an application executing in a computer in the data processing environment, a set of structured documents. The embodiment recognizes a structure, parts of which structure are present in the documents in the set. The embodiment summarizes a set of similarities in the documents in the set according to the recognized structure. The embodiment presents, responsive to the summarizing, a summarized information such that a document governance action can be performed on a subset of the set of documents using the summarized information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 depicts a block diagram of a data processing system in which the illustrative embodiments may be implemented;

FIG. 3 depicts a block diagram of an example set of structured documents with respect to which an illustrative embodiment may be implemented;

FIG. 4 depicts a block diagram of example components of an application implementing automated document governance in accordance with an illustrative embodiment;

FIG. 5 depicts block diagram of additional example components of an application implementing automated document governance in accordance with an illustrative embodiment;

FIG. 6 depicts block diagram of additional example components of an application implementing automated document governance in accordance with an illustrative embodiment;

FIG. 7 depicts a flowchart of a process of automating document governance in accordance with an illustrative embodiment;

FIG. 8 depicts a flowchart of another process of automating document governance in accordance with an illustrative embodiment; and

FIG. 9 depicts an example external process for applying rules in accordance with an illustrative embodiment.

### DETAILED DESCRIPTION OF THE PREFERRED EMBODIMENT

Governance of information, content, or documents is a process that causes the subject information, content, or documents to be distributed, reviewed, commented on, modified, authorized, certified, approved, or otherwise subjected to some supervision before such information, content, or documents may be used. A governance process or steps thereof are often built into some workflow in a given data processing environment. For example, given a certain type of document, a workflow may establish a flow of the document from one person to another, one system to another, or one application to another.

The invention recognizes that when dealing with a volume of information, such as hundreds or thousands of documents, the governance process can become tedious and time consuming. In many cases, the governance process can take unexpected detours that may not have been planned in a defined workflow. For example, the invention recognizes that certain governance steps have to be repeated several times, by same or different entities, before the content can be used for the intended purpose.

As an example, certain governance steps may apply commonly to several documents. For example, a review of several similar documents may identify changes that commonly apply to a set of documents. A set of documents is one or more documents. The invention recognizes that presently, no easy way exists for specifying feedback or comments that apply to a set of documents without having to repeat the comments for specific documents.

As another example, when subjecting a set of documents to some governance step, presently, no easy way exists for allocating subsets or collections of documents to different persons, systems, or processes, without repeating the allocation steps document-by-document. In other words, automatic delegation with specification of delegated actions has to be either pre-planned into a workflow or accomplished on a document-by-document basis.

As another example, when a set of documents encounter similar problems in a governance process, no easy way currently exists to automatically modify a preset workflow to accommodate a solution to the problem. For example, a workflow may specify a review process for a set of documents but a review or comment may necessitate further review iterations, additional or different approvals, or a combination thereof. Presently, to accommodate such alterations, each such document has to be handled manually on a document-by-document basis.

As another example, when a set of changes, comments, or recommendations are returned for a set of documents, at least some such changes may apply to a subset of the documents. Presently, changes or suggestions have to be examined and applied on a document-by-document basis.

The illustrative embodiments used to describe the invention generally address and solve the above-described problems and other problems related to governance processes. The illustrative embodiments of the invention provide a method, computer usable program product, and data processing system for automated document governance in a data processing environment.

Within this disclosure, structured information, content, or documents are each commonly referred to as a structured document, or simply, document. A structured document includes an organization of information such that like information is identifiable as being similar or dissimilar in similarly structured documents.

The illustrative embodiments are described with respect to data, data structures, and identifiers only as examples. Such descriptions are not intended to be limiting on the invention. For example, an illustrative embodiment described with respect to one type of structured document may be applied to a different type of structured information, in a similar manner within the scope of the invention. For example, a title may be an attribute of a structured document. An illustrative embodiment described with respect to a title attribute may be similarly applicable to another attribute, such as a description attribute of a structured document.

Furthermore, the illustrative embodiments may be implemented with respect to any type of data processing system. For example, an illustrative embodiment described with respect to a policy based system or a workflow engine may be applied to a peer-to-peer review or routing environment within the scope of the invention. As another example, an embodiment of the invention may be implemented with respect to any type of client system, server system, platform, or a combination thereof.

The illustrative embodiments are further described with respect to certain parameters, attributes, and configurations only as examples. Such descriptions are not intended to be limiting on the invention. For example, an illustrative embodiment described with respect to numeric attribute may be implemented using an alphanumeric attribute, a symbolic attribute, or a combination thereof, in a similar manner within the scope of the invention.

An application implementing an embodiment may take the form of data objects, code objects, encapsulated instructions, application fragments, drivers, routines, services, systems—including basic I/O system (BIOS), and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. or Oracle Corporation in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

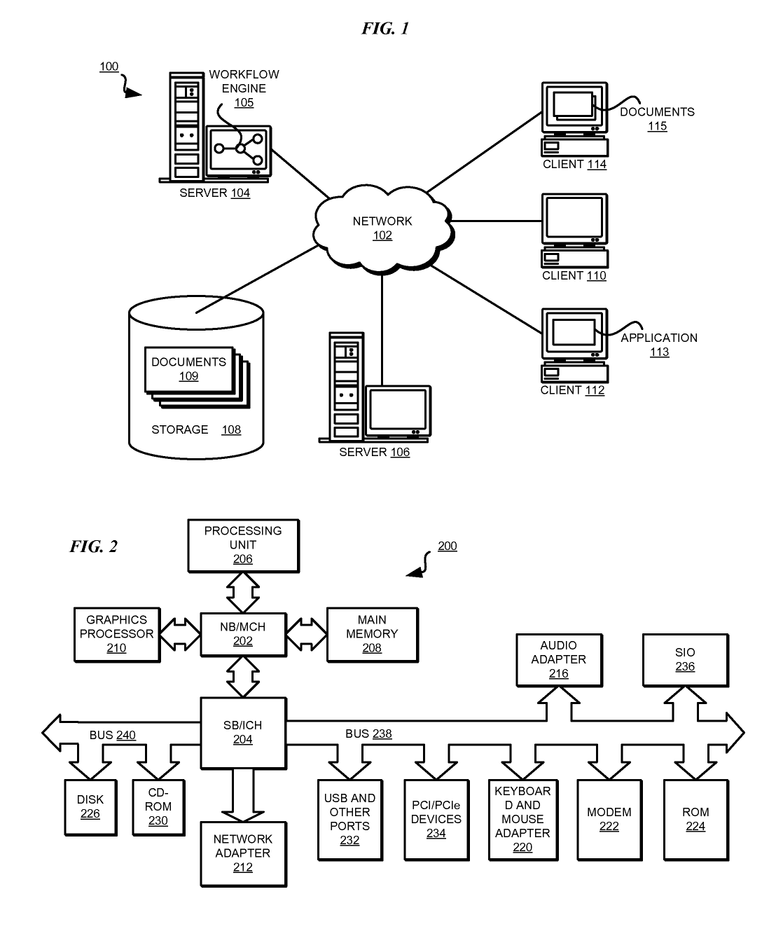

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include workflow engine 105 that may manage preplanned workflows for specified processes, including governance processes, within data processing environment 100. Storage 108 may include documents 109. Client 112 may include application 113, which may implement an embodiment of the invention. Client 114 may also include documents 115. Documents 109 and 115 are structured documents.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations. In some configurations, processing unit 206 may include NB/MCH 202 or parts thereof.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to south bridge and I/O controller hub 204 through bus 238. Hard disk drive (HDD) 226 and CD-ROM 230 are coupled to south bridge and I/O controller hub 204 through bus 240. PCl/PCIe devices may include, for example, Ethernet adapters, add-in cards, and PC cards for notebook computers. PCI uses a card bus controller, while PCIe does not. ROM 224 may be, for example, a flash binary input/output system (BIOS). In some configurations, ROM 224 may be an Electrically Erasable Programmable Read-Only Memory (EEPROM) or any other similarly usable device. Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

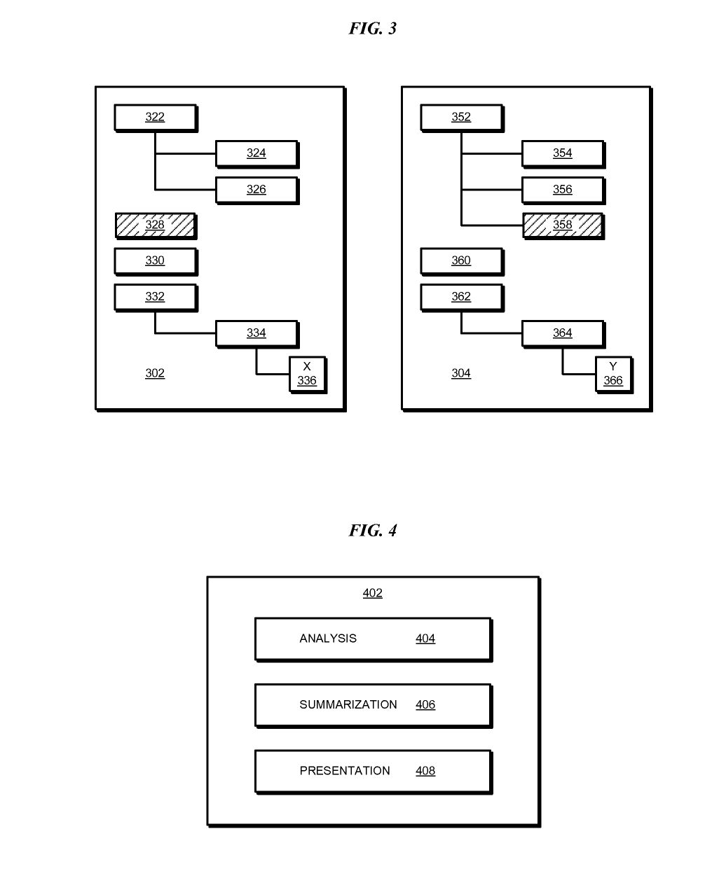

With reference to FIG. 3, this figure depicts a block diagram of an example set of structured documents with respect to which an illustrative embodiment may be implemented. Documents 302 and 304 are each example structured documents in a set of documents.

Generally, comparing two similarly structured documents is within the purview of current document comparison technologies. Even a small number, such as five or ten, of similar documents can be compared with some manual steps without a significant chance of error or tedious repetition. When the set of similar document exceeds a threshold size, for example, fifty, hundred, thousand, or even tens of thousands, governance of the set becomes problematic as recognized by the invention. For example, comparison, review, modification, distribution, or other governance activities of one hundred documents, even when largely similar in structure and/or content, can easily occupy an entire workday.

An embodiment of the invention may be significantly more useful than any currently available method, whether fully or partially manual, when large sets of similarly structured documents are subjected to governance processes. In the depicted example, documents 302 and 304 are two documents from such a large set.

Documents 302 and 304 are shown to include a structured organization of information therein. The structure of a document may follow any order, grouping, recurrence, dependence, hierarchy, type, form, or specification within the scope of the invention. For example, document 302 includes pieces of information 322, 324, 326, 328, 330, 332, 334, and 336 organized in the depicted structure that shows some order, hierarchy, and repetition only as examples without limitation. Similarly, document 304 includes pieces of information 352, 354, 356, 358, 360, 362, 364, and 366 organized in the depicted structure that shows some order, hierarchy, and repetition, having some similarity to the structure of document 302.

As depicted, the structures of documents 302 and 304 differ in some respects and are similar in other respects. For example, information 322 and 352, 324 and 354, 326 and 356 correspond to each other in their position or organization within documents 302 and 304 respectively. However, information 358 in document 304 does not appear to have corresponding information similarly located in document 302. Information 328 in document 302 does not appear to have corresponding information similarly located in document 304.

The structures may differ not only in the organization but also in the attributes and values stored within the structures. For example, information 336 in document 302 holds the value “X”, whereas, corresponding information 366 in document 304 holds the value “Y” in otherwise similar organization of the two documents. A large set of documents may have these and other similar types of variations among themselves.

With reference to FIG. 4, this figure depicts a block diagram of example components of an application implementing automated document governance in accordance with an illustrative embodiment. Application 402 may be implemented as application 113 in FIG. 1.

Application 402 may apply, or assist in applying steps of a governance process to a set of documents including documents such as documents 302 and 304 in FIG. 3. Analysis component 404 performs a two step analysis of the set of documents. As a preliminary analysis, component 404 identifies a structure all or part of which is present in the documents of the set. As a second part of the analysis, component 404 determines whether the structures, sub-structures, values therein, or a combination thereof are sufficiently similar between the documents in set.

The sufficiency of the similarity can be tuned according to particular implementation's needs. For example, in one embodiment, for the documents to be sufficiently similar, at least a threshold percent of the structure may have to be similar across all the documents in the set.

In another embodiment, for the documents to be sufficiently similar, at least a threshold number of positions in the structures of the various documents may have to hold similar values in the documents in the set. In another embodiment, for the documents to be sufficiently similar, at least no more than a threshold number of differences in positions in the structures or the values therein may exist in the documents in the set.

These examples of when the documents in a set may be regarded as sufficiently similar are provided only as examples and not as limitations on the invention. Many other ways of comparing structured documents to determine whether they similar beyond a threshold level of similarity in structure, values, or both, will be apparent from this disclosure and the same are contemplated within the scope of the invention.

Based on the result of the analysis, component 404 may determine whether the set of documents is similar beyond a threshold to continue with the automated document governance process of an embodiment. If the analysis of component 404 reveals that the documents in the set are not sufficiently similar, an embodiment may not be able to automate the governance process steps and the set may have to be processed using an existing process of governance.

If the set contains similarities that are sufficient to process using an embodiment, summarization component 406 summarizes the similarities and the differences between the documents in the set. For example, the set may include role definition records of a certain number of users. A reviewer may receive the role records for review and approval before the roles can be deployed in a data processing environment. Assuming that the role information structure is similar in the application name for which the roles are being created, policies that apply to the roles, but different in user name values, and that one additional policy applies to certain users.

Summarization component 406 may summarize the information as follows:

| Total roles to review | 10 |
|---|---|
| Roles 1-10 have the following common values: | |
| Application name | App1 |
| Policy | P1, P2 |
| Roles 1-10 are different in: | |
| Usernames | |
| Role 5 includes: | |
| Additional Policy | P5 |

Presentation component 408 may present this summarized information to the person, application, or system undertaking the governance step. For example, if a reviewer is to review the role records, component 408 may present such a summary to the reviewer.

Advantageously, these actions of component 404, 406, and 408 allow a governance step to be automated to the extent that the governance step may omit reviewing a set of documents document-by-document and utilize the summarized information to execute the governance step. For example, based on the above example summary, the example reviewer may be able to approve the roles, or take other actions as described elsewhere in this disclosure without having to actually review the role record documents.

With reference to FIG. 5, this figure depicts block diagram of additional example components of an application implementing automated document governance in accordance with an illustrative embodiment. Components of application 502 may be implemented together with components of application 402 in FIG. 4, or separately there from, as application 113 in FIG. 1.

Component 504 may be a “receive instructions” component configured to receive an instruction from a person, system, or application according to a governance step. For example, in the example of role records described above with respect to FIG. 4, upon reviewing the summary, the reviewer may input an instruction in any suitable form, including plain text. For example, the reviewer may send, and component 504 may receive, an instruction, “change App1 to App3 for all roles but role 5.”

Using existing document governance methods, a reviewer has to either make or note the change on a document-by-document basis, or instruct a source of the document by departing the workflow, such as by email or another separate communication. Using an embodiment, such as described with respect to FIG. 5, advantageously, the reviewer can provide the instruction within the governance process workflow (e.g., while remaining in the review step of the process), without having to review each document in the set, and without changing or noting the change in each or some affected documents in the set.

Rule construction component 506 is configured to decompose an instruction received by component 504 and create a rule logic that can be executed by an application. For example, the example instruction, “change App1 to App3 for all roles but role 5” may be converted into suitable code according to the following logic or pseudo-code:

```
For each document where role NotEqualTo 5
      If application name=”App1”
        Application name=”App3”
      end
```

In a similar manner, any instruction in any form can be parsed, translated, converted, or otherwise transformed into an executable rule using one or more steps of transformation. Thus, component 504 receives an instruction and rule construction component 506 transforms the instruction into a rule.

Workflow component 508 may determine whether a rule created by component 506 requires modification of an existing workflow. For example, in the above example instruction and rule, the role records may have to be returned to the source of the role records to perform the modifications. An existing workflow for role deployment may not include a step for returning the roles to the source for modification. Accordingly, component 508 may modify, send instructions to modify, or inform an application or person to modify the workflow to include a return step and perhaps a second review step.

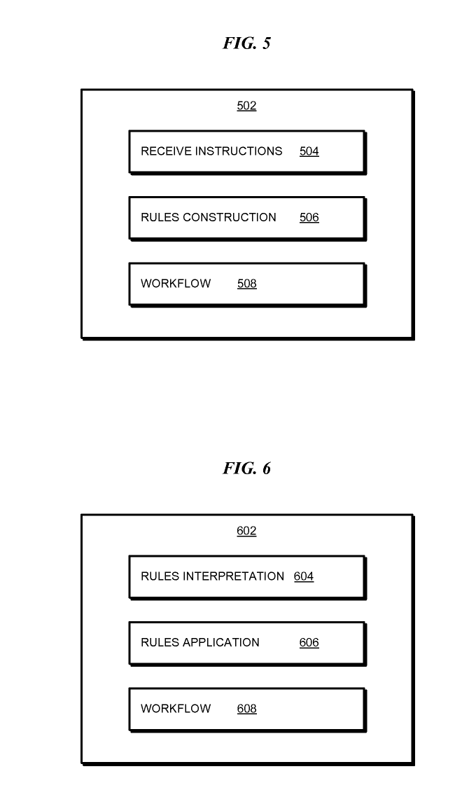

With reference to FIG. 6, this figure depicts block diagram of additional example components of an application implementing automated document governance in accordance with an illustrative embodiment. Components of application 602 may be implemented together with components of application 402 in FIG. 4, components of application 502 in FIG. 5, or separately there from, as application 113 in FIG. 1.

Rules interpretation component 604 may receive a rule created from an instruction. For example, component 604 may receive the example rule created by component 506 in FIG. 5 as described above. Component 604 may further transform the rule to make the rule suitable for execution in a given environment. For example, component 604 may transform code of the rule from one language to another or resolve indirect references to files, memory, or resources. As another example, a rule may have to be combined with another rule or modified according to a policy, and rules interpretation component 604 may perform the combining or modification of rules.

Rules application component 606 applies one or more rules to a set of documents. Component 604 may interpret, execute, or otherwise perform the rule resulting from component 604 with respect to the set of documents in question.

Workflow component 608 may be the same as component 508 in FIG. 5 if the components of FIGS. 5 and 6 are in the same application. Workflow component 608 may be similar to but separate from component 508 in FIG. 5 if the components of FIGS. 5 and 6 are in different applications. Workflow component 608 performs a similar function as described with respect to component 508 in FIG. 5.

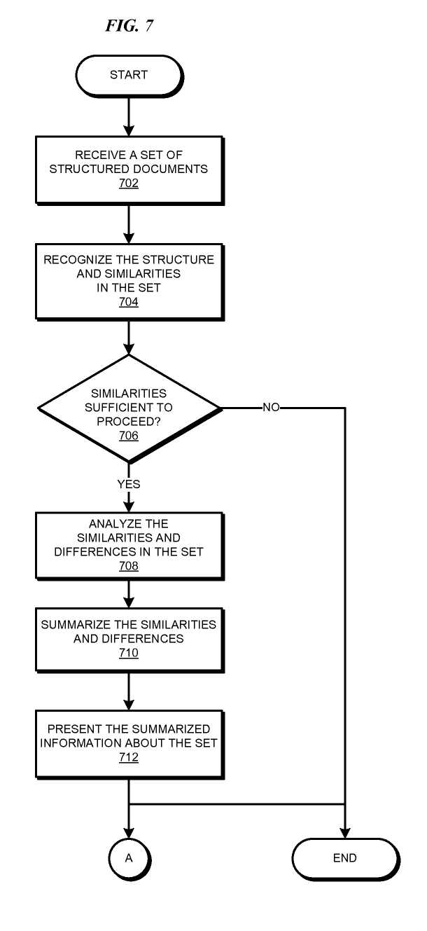

With reference to FIG. 7, this figure depicts a flowchart of a process of automating document governance in accordance with an illustrative embodiment. Process 700 may be implemented in an application, such as application 402 in FIG. 4, application 502 in FIG. 5, application 602 in FIG. 6, or a combination thereof.

Process 700 begins by receiving a set of structured documents (step 702). Process 700 recognizes the structure and similarities in the documents in the set (step 704).

Process 700 determines whether the structure and/or content are similar meet or exceed a threshold (step 706). If the similarities do not meet or exceed the threshold (“No” path of step 706), process 700 may end thereafter.

If the similarities meet or exceed the threshold (“Yes” path of step 706), process 700 analyzes the similarities and the differences in the documents in the set (step 708). Process 700 summaries the similarities and the differences (step 710). In one embodiment, only the similarities or the differences may be summarized.

Process 700 presents the summarized information about the set (step 712). Process may end thereafter, or exit at exit point marked “A” to enter another process having a corresponding entry point marked “A”.

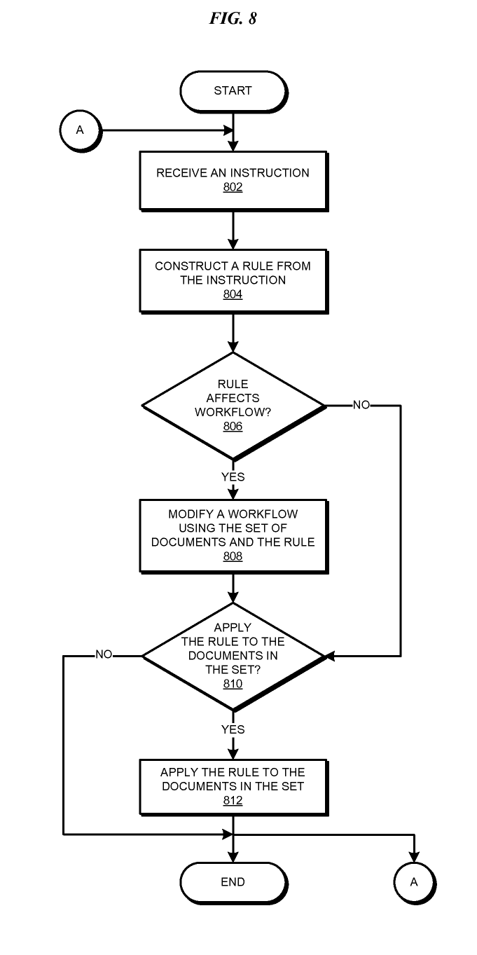

With reference to FIG. 8, this figure depicts a flowchart of another process of automating document governance in accordance with an illustrative embodiment. Process 800 may be implemented in an application, such as application 402 in FIG. 4, application 502 in FIG. 5, application 602 in FIG. 6, or a combination thereof.

Process 800 begins by receiving an instruction pertaining to a governance action applicable to a given set of structured documents (step 802). Process 800 constructs a rule from the instruction of step 802 (step 804). Process 800 determines whether the rule affects a workflow (step 806). If a workflow is affected (“Yes” path of step 806), process 800 modifies or instructs to modify the relevant workflow using the set of documents and the rule (step 808). If a workflow is not affected (“No” path of step 806), process 800 proceeds to step 810.

Process 800 determines whether to apply the rule to one or more documents in the set (step 810). If the rule has to be applied (“Yes” path of step 810), process 800 applies the rule to the relevant documents in the set (step 812). Process 800 may end thereafter, or return to step 802, such as to receive further instructions. If the rule is not to be applied, such as when the rule is to be applied in another process, or when the rule is for notifying a user or an application (“No” path of step 810), process 800 may end thereafter, or return to step 802.

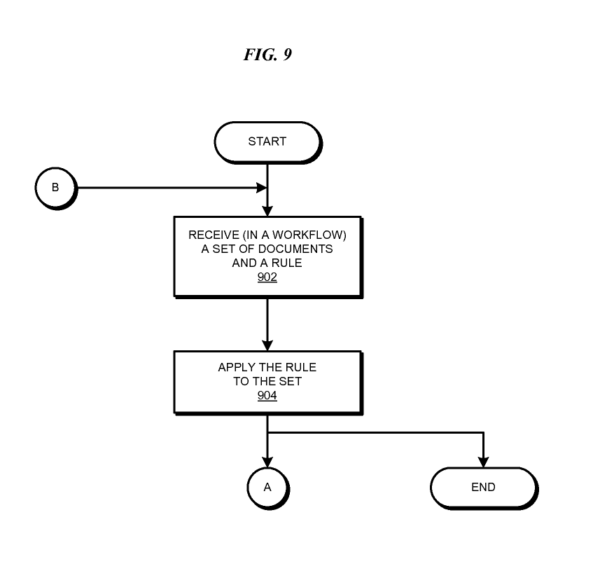

With reference to FIG. 9, this figure depicts an example external process for applying rules in accordance with an illustrative embodiment. Process 900 may be implemented in a workflow engine, such as workflow engine 105 in FIG. 1.

Process 900 receives a set of documents and a rule (step 902). For example, process 800 in FIG. 8 may provide the rule and the set of documents to the workflow engine executing process 900. Process 900 executes the rule with respect to the set of documents, such as by selecting the relevant documents from the set and modifying them according to the rule (step 904). Process 900 ends thereafter.

As an example, a team of reviewers may be collaborating on a set of documents. For example, different members of the team may be able to review subsets of the set of documents. A workflow may be setup to coordinate and delegate the review process among the team members and parts of such a workflow may pertain to the review process of each reviewer. Process 800 in FIG. 8 may receive an instruction from a lead reviewer in the team to “distribute the documents pertaining to users whose last names begin from A-G to reviewer 1, distribute the documents pertaining to users whose last names begin from H-R to reviewer 2, and the rest to reviewer 3.” At step 806, process 800 in FIG. 8 may determine that a rule resulting from such an instruction modifies the review delegation workflow as well as review process workflows of several reviewers. In step 808, process 800 of FIG. 8 modifies those workflows by inserting the subsets of identified documents and/or their review instructions or rules.

In this example operation, process 900 may then receive the subsets of documents and/or instructions or rules in step 902. Process 900 apply a received rule or instruction to the received subset of documents. Process 900 may then exit at exit point marked “A” and enter process 800 in FIG. 8, for example, to receive further instructions from the reviewer handling the received subset of documents.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for automated document governance in a data processing environment. Using an embodiment of the invention, governance of information, content, or documents may be significantly automated such that governance action specific information is distilled from a set of structured documents and is summarized in a manner that allows for specifying instructions with respect to groups of documents instead of reviewing or modifying each document in the set.

The instructions are converted into executable rules. Any person, system, or application participating in the governance action can specify the instruction that can be converted into a rule. For example, a reviewer can provide an instruction based on a review, an author can receive review comments and provide instructions to modify the documents according to the review comments.

Furthermore, a workflow in a given data processing environment may be modified according to an embodiment to accept documents and rules, and to incorporate additional or different steps based thereon.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for automated document governance in a data processing environment, the computer implemented method comprising:
receiving at an application executing in a computer in the data processing environment, a set of structured documents;
recognizing a structure, parts of which structure are present in the documents in the set;
summarizing a set of similarities in the documents in the set according to the recognized structure; and
presenting, responsive to the summarizing, a summarized information such that a document governance action can be performed on a subset of the set of documents using the summarized information.

2. The computer implemented method of claim 1, wherein the summarizing further includes summarizing a set of differences in the documents in the set, further comprising:
receiving an instruction to manipulate the subset, the instruction corresponding to the governance action;
converting the instruction into an executable rule; and
executing the rule to manipulate the subset of documents according to the instruction.

3. The computer implemented method of claim 2, wherein the instruction is in plaintext and the rule is executable code.

4. The computer implemented method of claim 2, further comprising:
determining whether the instruction requires a workflow pertaining to the set of documents to be modified;
modifying the workflow responsive to the determining being affirmative.

5. The computer implemented method of claim 2, further comprising:
modifying the rule according to a policy prior to the executing.

6. The computer implemented method of claim 2, wherein the receiving, the converting, and the executing are repeated after the governance action in a workflow.

7. The computer implemented method of claim 1, wherein a first part of the structure in a first document in the set is within a threshold level of similarity to a second part of the structure in a second document in the set.

8. A computer usable program product comprising a computer usable storage medium including computer usable code for automated document governance in a data processing environment, the computer usable code comprising:
computer usable code for receiving at an application executing in a computer in the data processing environment, a set of structured documents;
computer usable code for recognizing a structure, parts of which structure are present in the documents in the set;
computer usable code for summarizing a set of similarities in the documents in the set according to the recognized structure; and
computer usable code for presenting, responsive to the summarizing, a summarized information such that a document governance action can be performed on a subset of the set of documents using the summarized information.

9. The computer usable program product of claim 8, wherein the summarizing further includes summarizing a set of differences in the documents in the set, further comprising:
computer usable code for receiving an instruction to manipulate the subset, the instruction corresponding to the governance action;
computer usable code for converting the instruction into an executable rule; and
computer usable code for executing the rule to manipulate the subset of documents according to the instruction.

10. The computer usable program product of claim 9, wherein the instruction is in plaintext and the rule is executable code.

11. The computer usable program product of claim 9, further comprising:
computer usable code for determining whether the instruction requires a workflow pertaining to the set of documents to be modified;
computer usable code for modifying the workflow responsive to the determining being affirmative.

12. The computer usable program product of claim 9, further comprising:
computer usable code for modifying the rule according to a policy prior to the executing.

13. The computer usable program product of claim 9, wherein the receiving, the converting, and the executing are repeated after the governance action in a workflow.

14. The computer usable program product of claim 8, wherein a first part of the structure in a first document in the set is within a threshold level of similarity to a second part of the structure in a second document in the set.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A computer usable program product comprising a computer usable storage medium including computer usable code for automated document governance in a data processing environment, the computer usable code comprising:
computer usable code for receiving at an application executing in a computer in the data processing environment, a set of structured documents;
computer usable code for recognizing a structure, parts of which structure are present in the documents in the set;
computer usable code for summarizing a set of similarities in the documents in the set according to the recognized structure; and
computer usable code for presenting, responsive to the summarizing, a summarized information such that a document governance action can be performed on a subset of the set of documents using the summarized information.

18. The computer usable program product of claim 17, wherein the summarizing further includes summarizing a set of differences in the documents in the set, further comprising:
computer usable code for receiving an instruction to manipulate the subset, the instruction corresponding to the governance action;
computer usable code for converting the instruction into an executable rule; and
computer usable code for executing the rule to manipulating the subset of documents according to the instruction.

19. The computer usable program product of claim 18, wherein the instruction is in plaintext and the rule is executable code.

20. The computer usable program product of claim 18, further comprising:
computer usable code for determining whether the instruction requires a workflow pertaining to the set of documents to be modified;
computer usable code for modifying the workflow responsive to the determining being affirmative.
